(19) United States
(12) Patent Application Publication
(10) Pub. No.: US 2010/0096113 A1
(43) Pub. Date: Apr. 22, 2010

(54) HYBRID SURFACES THAT PROMOTE DROPWISE CONDENSATION FOR TWO-PHASE HEAT EXCHANGE

(75) Inventors: Kripa Kiran Varanasi, Clifton Park, NY (US); Tao Deng, Clifton Park, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: General Electric Company, Schenectady, NY (US)

(21) Appl. No.: 12/254,561

(22) Filed: Oct. 20, 2008

(51) Int. Cl. F28F 19/02; B23P 17/00; B32B 3/10

(52) U.S. Cl. 165/133; 29/592; 428/158

(57) ABSTRACT

An article comprising a hybrid surface for promoting dropwise liquid condensation is disclosed herein. The article comprises an array, wherein the array comprises a plurality of raised structures. The plurality of raised structures comprise at least one geometric shape. The plurality of raised structures also comprise a hydrophobic surface. The article also comprises a plurality of hydrophilic pores interspersed between the plurality of raised structures. Methods for constructing a hybrid surface for promoting dropwise liquid condensation are disclosed herein. A heat transfer device comprising a hybrid surface for promoting dropwise liquid condensation is also disclosed herein.

### BACKGROUND

Condensation of a vaporized liquid phase comprises an efficient route of heat transfer. In an exemplary liquid vaporization process, a heat source gives up heat to a liquid, which thereafter enters the gas phase when sufficient heat has been transferred to the liquid to affect vaporization. Transfer of heat to the liquid lowers the temperature of the heat source in the process. The vaporized liquid may thereafter be condensed on a cooling surface, whereupon the condensed liquid releases the heat it previously obtained during the vaporization process. Condensation generally occurs when the vapor comes into contact with a cooling surface having a temperature below the saturation temperature of the vapor. The temperature of the cooling surface is raised in the condensation process. The cooling surface may conduct the transferred heat away from the system through thermal conductance, which may comprise cooling of the surface through air cooling, water cooling, refrigeration, and the like. Thus, vaporization of a liquid comprises transferring heat from a heat source to a heat sink. Condenser systems of this type are commonly used in power generation plants, chemical processing facilities, desalination plants, and refrigeration systems.

There are two primary mechanisms through which a liquid may condense on a cooling surface. In the first mechanism, the liquid may condense as a film coating the cooling surface. In the second mechanism, the liquid may condense in defined droplets covering the surface. Heat transfer capacity of the cooling surface may be reduced by filmwise condensation, since the liquid film generally reduces the thermal conductance between the vapor and the cooling surface. Reduced thermal conductance becomes more prevalent as the liquid film becomes thicker. Also as the liquid film becomes thicker, shedding of the liquid from the surface occurs. Dropwise condensation, in contrast, generally provides improved thermal conductance over filmwise condensation, since there is no intervening film between the vapor and the cooling surface.

A droplet of condensed liquid residing on a microscopically textured surface may exist in any one of a number of equilibrium states. In the “Cassie” state, a number of air pockets are trapped beneath the droplet. In the “Wenzel” state, the droplet wets the entire surface beneath it, filling the voids containing trapped air in the “Cassie” state. There are numerous equilibrium states existing between these two extremes. As used herein, the term “non-Wenzel” state describes these intermediate states as well as the “Cassie” state. The interaction energy of the droplet with the surface may be determined by the state in which the droplet exists on the surface. The surface interaction energy further guides how easily droplets are shed from the surface. The condensed droplets may be shed from the cooling surface by gravity or aerodynamic forces. If gravity, aerodynamic forces, or the like are exceeded by the surface interaction forces pinning the droplet to the cooling surface, the droplet is not easily shed and cooling efficiency may decrease. The droplet shedding process creates fresh nucleation sites on the cooling surface, which allows for further dropwise condensation to occur. In certain instances, dropwise condensation is an unstable process, which is eventually superseded by filmwise condensation. Dropwise condensation may be promoted by reducing the wettability of the cooling surface toward the vaporized liquid. Modifying the cooling surface to reduce wettability may be accomplished by methods such as including an additive in making the surface or covering the cooling surface with a coating, such as a polymer film.

In view of the foregoing, it would be beneficial to develop surfaces for heat transfer that promote dropwise condensation and droplet shedding under conditions typically resistant to dropwise condensation. These conditions may include gravitational, aerodynamic, or services stresses encountered in operation of the heat transfer surfaces. Heat transfer surfaces not relying on gravitational forces or aerodynamic forces for shedding of droplets may provide advantageous benefit in this regard.

### BRIEF DESCRIPTION OF THE DISCLOSURE

In the most general aspects, the present disclosure describes an article comprising a hybrid surface for promoting dropwise liquid condensation. The hybrid surface comprises an array comprising plurality of raised structures, wherein the plurality of raised structures comprise at least one geometric shape and a hydrophobic surface. The hybrid surface also comprises a plurality of hydrophilic pores interspersed between the plurality of raised structures.

In other aspects, the present disclosure provides a method for constructing a hybrid surface for promoting dropwise liquid condensation. The method comprises the steps of providing an anchoring structure, preparing an array comprising a plurality of raised structures, and interspersing a plurality of hydrophilic pores between the plurality of raised structures. The plurality of raised structures comprise at least one geometric shape and are bound to the anchoring structure. Distal ends of the plurality of raised structures comprise a hydrophobic surface.

In still other aspects, the present disclosure describes a heat transfer device comprising a hybrid surface for promoting dropwise liquid condensation. The heat transfer device comprises an anchoring structure, an array comprising a plurality of raised structures, and a plurality of hydrophilic pores interspersed between the plurality of raised structures. The plurality of raised structures comprise at least one geometric shape and are bound to the anchoring structure. Distal ends of the plurality of raised structures comprise a hydrophobic surface. The plurality of hydrophilic pores comprises a plurality of micro-capillaries. The hybrid surface comprising the heat transfer device comprises at least one substance having a high thermal conductivity.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings, in which:

FIG. 1 shows representative embodiments of the contact angle between a droplet and a surface.

FIG. 2 shows a top view of an embodiment of a hybrid surface disclosed herein.

FIG. 3 shows a side view of an embodiment of a hybrid surface disclosed herein.

FIG. 4 shows an SEM image of a representative hydrophobic surface embodiment of the present disclosure before and after dropwise condensation of water on the surface.

FIG. 5 shows a representative embodiment of a heat pipe prepared using the hybrid surface described herein.

FIG. 6 shows a representative embodiment of deposition, growth, and removal of a water droplet from a hybrid surface.

FIG. 7 shows a representative embodiment of deposition, growth, and removal of a water droplet from a hybrid surface.

### DETAILED DESCRIPTION OF THE DISCLOSURE

In the following description, certain details are set forth such as specific quantities, sizes, etc. so as to provide a thorough understanding of the present embodiments disclosed herein. However, it will be obvious to those skilled in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing a particular embodiment of the disclosure and are not intended to be limiting thereto. Drawings are not necessarily to scale.

While most of the terms used herein will be recognizable to those of skill in the art, the following definitions are nevertheless put forth to aid in the understanding of the present disclosure. It should be understood, however, that when not explicitly defined, terms should be interpreted as adopting a meaning presently accepted by those of skill in the art.

“Capillary force,” as defined herein, is the means through which a structure draws a liquid into the structure and moves the liquid through the structure. In an embodiment disclosed herein, capillary forces provide for movement of a liquid through micro-capillaries. Movement under the influence of a capillary force is also referred to as “wicking.” The process of moving a liquid through a capillary is referred to as capillary action.

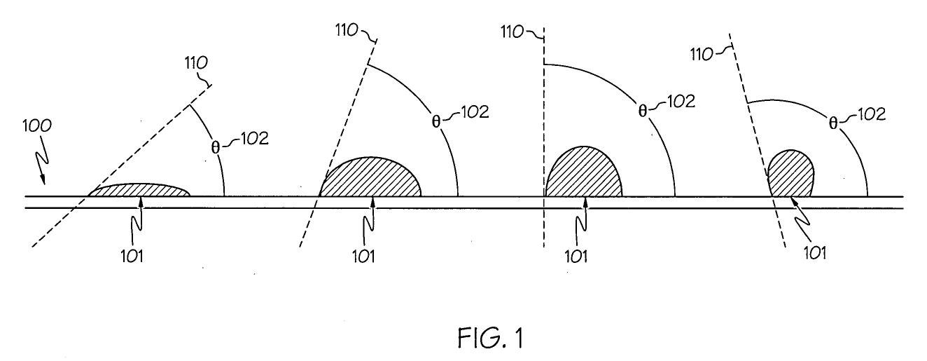

“Contact angle,” as defined herein, is a measure of the wettability of a surface by a liquid. As shown in FIG. 1, contact angle is defined as the angle θ (102) between surface (100) and tangent line (110) drawn at the point of contact between surface (100) and droplet (101). A small contact angle indicates a high surface wettability by the liquid. A large contact angle indicates low surface wettability by the liquid. As illustrated in FIG. 1, contact angle successively increases from left to right, indicating progressively less surface wetting. Hydrophilic surfaces demonstrate low value contact angles with water droplets. Hydrophobic surfaces demonstrate high contact angles with water droplets.

“Distal,” as defined herein, refers to an object or surface situated away from or opposite to its point of attachment to another object or surface.

“Hybrid surface,” as defined herein, refers to a surface comprising at least two definable regions having different physical properties. In an embodiment, a hybrid surface comprises a hydrophobic surface and a plurality of hydrophilic pores.

“Hydrophilic,” as defined herein, refers to a strong affinity for water or polar liquids. In an embodiment, a hydrophilic substance displays a high wettability by water.

“Hydrophobic,” as defined herein, refers to a poor affinity for water or polar liquids and a strong affinity for non-polar liquids.

“Hydrophobic hardcoating,” as defined herein, refers to a class of coatings that have a hardness greater than that of metals and a contact angle with water of at least about 70 degrees. Exemplary hydrophobic hardcoatings may include, but are not limited to, nitrides and carbides.

“Hydrophobic substance,” as defined herein, comprises a substance that demonstrates a low wettability by water.

“Inclined,” as defined herein, refers to a substantially planar surface, wherein the substantially planar surface is not perpendicular to a longitudinal axis intersecting the substantially planar surface.

“Proximal,” as defined herein, refers to an object or surface situated next to or adjacent to its point of attachment to another object or surface.

“Substantially planar surface,” as defined herein, refers to a surface comprising a plane that is macroscopically flat. A substantially planar surface may be textured on a microscopic level. A substantially planar surface may be perpendicular to or not perpendicular to a longitudinal axis intersecting the substantially planar surface.

“Working liquid,” as defined herein, refers to a heat transfer liquid in a heat pipe. The working liquid is vaporized and condenses on a cooling surface in the heat pipe. The condensation process transfers heat to the cooling surface.

It is to be understood that in any of the embodiments described hereinbelow, hydrophobic substances may refer to substances that demonstrate a low wettability by water. A hydrophobic substance may be characterized in any of the embodiments described hereinbelow by the contact angle water droplets make with the surface. In some embodiments disclosed hereinbelow, a hydrophobic substance may provide a contact angle with water greater than about 70 degrees. In other embodiments disclosed hereinbelow, a hydrophobic substance may provide a contact angle with water between about 70 degrees and about 90 degrees and all subranges thereof. In still other embodiments disclosed hereinbelow, a hydrophobic substance may provide a contact angle with water between about 90 degrees and about 120 degrees and all subranges thereof. In still other embodiments disclosed hereinbelow, a hydrophobic substance may provide a contact angle with water greater than about 120 degrees. A hydrophobic substance with a contact angle greater than about 120 degrees may be referred to as a superhydrophobic substance.

Certain embodiments disclosed hereinbelow comprise an anchoring structure. It is to be understood that the anchoring structure in any of the embodiments disclosed hereinbelow may comprise a planar surface or a three-dimensional shape. The anchoring structure may comprise a flat surface. The anchoring structure may also comprise a three-dimensional shape, such as a concave surface or a convex surface. Any of the embodiments of anchoring structures disclosed hereinbelow may comprise texturing features including, but not limited to, ridges, valleys, pits, serrations, bumps, patterning, and combinations thereof. In the embodiments hereinbelow, materials suitable for constructing the anchoring structure may include at least one material chosen from the group including, but not limited to, glass, diamond, ceramics, metals, and semi-metals. It is to be understood that the term metal comprises elemental metallics, alloys, intermetallic compounds, and other such compositions comprising metals, such as aluminides. In the embodiments hereinbelow, exemplary metals for constructing the anchoring structure may comprise at least one member chosen from the group including, but not limited to, iron, nickel, cobalt, chromium, aluminum, copper, titanium, platinum, gold, silver, and alloys thereof. In the embodiments hereinbelow, exemplary ceramics for constructing the anchoring structure may comprise a nitride or a carbide. In certain embodiments hereinbelow, ceramics comprise at least one member chosen from the group including, but not limited to, aluminum nitride and silicon carbide. An exemplary semi-metal for constructing the anchoring structure comprises elemental silicon in an embodiment.

Certain embodiments disclosed hereinbelow comprise a plurality of raised structures, which may comprise at least one geometric shape. It is to be understood that the raised structures referred to in any of the embodiments disclosed hereinbelow may cylindrical, prismatic, spherical, hemispherical, pyramidal, or any combination thereof. The raised structures may be un-tapered or tapered. The raised structures may be further described as comprising at least one geometric shape, which comprises at least one end of the raised structure. Geometric shapes which may comprise the raised structure may include at least one shape selected from the group including, but not limited to, circles, ovals, triangles, squares, rectangles, parallelograms, diamonds, trapezoids, rhombuses, pentagons, hexagons, heptagons, octagons, nonagons, decagons, and polygons. Such geometric shapes may be regular or irregular. Non-polygonal shapes may also comprise the geometric shape comprising the raised structure. In certain embodiments hereinbelow, at least one end of the raised structures may be altered to create a convex surface or a substantially planar surface. In any of the embodiments hereinbelow, materials suitable for constructing the raised structures may include at least one material chosen from the group including, but not limited to, glass, diamond, ceramics, metals, and semi-metals. It is to be understood that the term metal comprises elemental metallics, alloys, intermetallic compounds, and other such compositions comprising metals, such as aluminides. In any of the embodiments hereinbelow, exemplary metals for constructing the raised surface may comprise at least one member chosen from the group including, but not limited to, iron, nickel, cobalt, chromium, aluminum, copper, titanium, platinum, gold, silver, and alloys thereof. In any of the embodiments hereinbelow, exemplary ceramics for constructing the raised surface may comprise a nitride or a carbide. In certain embodiments hereinbelow, ceramics comprise at least one member chosen from the group including, but not limited to, aluminum nitride and silicon carbide. An exemplary semi-metal for constructing the raised surface comprises elemental silicon in an embodiment.

Certain embodiments disclosed hereinbelow refer to a substance having a high thermal conductivity. It is to be understood that substances having a high thermal conductivity in any of the embodiments disclosed hereinbelow may include at least one substance chosen from the group including, but not limited to, metals, glass, diamond, ceramics, and semi-metals. It is to be understood that the term metal comprises elemental metallics, alloys, intermetallic compounds, and other such compositions comprising metals, such as aluminides. In the embodiments described hereinbelow, metals having a high thermal conductivity may comprise at least one member chosen from the group including, but not limited to, iron, nickel, cobalt, chromium, aluminum, copper, titanium, platinum, gold, silver, and alloys thereof. In the embodiments described hereinbelow, ceramics having a high thermal conductivity may comprise a nitride or a carbide. In certain embodiments hereinbelow, ceramics comprise at least one member chosen from the group including, but not limited to, aluminum nitride and silicon carbide. An exemplary semi-metal having a high thermal conductivity comprises elemental silicon in an embodiment.

Certain embodiments disclosed hereinbelow refer to a hydrophobic surface. It is to be understood that a hydrophobic surface may be inherently hydrophobic, modified to confer hydrophobicity, or covered with at least one hydrophobic substance to confer hydrophobicity. A hydrophobic substance may comprise a material characterized by a certain contact angle with water, as described in embodiments detailed hereinabove. In any of the embodiments hereinbelow, the hydrophobic surface may comprise at least one material chosen from the group including, but not limited to glass, diamond, metals, ceramics, semi-metals, and polymers. It is to be understood that the term metal comprises elemental metallics, alloys, intermetallic compounds, and other such compositions comprising metals, such as aluminides. In the embodiments described hereinbelow, exemplary metals comprising a hydrophobic surface may comprise at least one metal chosen from the group including, but not limited to, iron, nickel, cobalt, chromium, aluminum, copper, titanium, platinum, gold, silver, and alloys thereof. In any of the embodiments hereinbelow, the surface may be modified to confer hydrophobicity through diffusion or implantation of molecular, atomic, or ionic species into the surface comprising the hydrophobic surface. Implantation of at least one ion selected from the group consisting of ions comprising B, N, F, C, O, He, Ar or H may lower the surface contact energy and decrease wettability. In an embodiment, the diffusion or implantation process may comprise a nitriding process or a carburizing process. Nitriding and carburizing processes are known in the art to harden metal surfaces and lower surface contact energy. In other embodiments hereinbelow, the hydrophobic surface may be covered with a hydrophobic substance. The hydrophobic substance may comprise a textured surface in an embodiment. It is to be understood that a hydrophobic substance for covering a surface referred to in any of the embodiments hereinbelow may comprise at least one material selected from the group including, but are not limited to hydrophobic hardcoatings, fluorinated materials, and polymers. Hydrophobic hardcoatings may include, but are not limited to, diamond-like coatings, fluorinated diamond-like coatings, nitrides, carbides, oxides, and combinations thereof. Nitrides, carbides, and oxides may be comprised by metals or non-metals. In certain embodiments, the hydrophobic hardcoating may comprise at least one nitride selected from the group including, but not limited to, titanium nitride, chromium nitride, boron nitride, zirconium nitride, and titanium carbonitride. In certain embodiments, the hydrophobic hardcoating may comprise at least one carbide selected from the group including, but not limited to, chromium carbide, molybdenum carbide, and titanium carbide. In certain embodiments, hydrophobic hardcoatings may comprise at least one oxide, such as tantalum oxide. In an embodiment, any combination of nitrides, carbides, and oxides may comprise the hydrophobic hardcoating. Hydrophobic hardcoatings may be applied through methods known to those skilled in the art including, but not limited, to chemical vapor deposition (CVD) and physical vapor deposition (PVD). In embodiments hereinbelow, fluorinated materials may comprise the hydrophobic substance. An exemplary but non-limiting example of a class of fluorinated materials which may comprise the hydrophobic substance includes, but is not limited to, fluorosilanes. In an embodiment, a fluorosilane comprises tridecafluoro-1,1,2,2-tetrahydrooctyl-trichlorosilane. In other embodiments hereinbelow, at least one polymer may comprise the hydrophobic substance. Polymers comprising the hydrophobic substance may include at least one component selected from the group including, but not limited to, thermoplastic polymers, thermosetting polymers, co-polymers, polymer composites, polysiloxanes, fluoropolymers, polyurethanes, polyacrylates, polysilazines, polyimides, polycarbonates, polyether imides, polystyrenes, polyolefins, polypropylenes, polyethylenes, epoxies, and combinations thereof.

In the most general aspects, the present disclosure describes an article comprising a hybrid surface for promoting dropwise liquid condensation. The hybrid surface comprises an array comprising plurality of raised structures, wherein the plurality of raised structures comprise at least one geometric shape. The plurality of raised structures also comprise a hydrophobic surface. The hybrid surface also comprises a plurality of hydrophilic pores interspersed between the plurality of raised structures. In some embodiments disclosed herein, dropwise liquid condensation comprises dropwise condensation of water. In certain embodiments, the article comprising a hybrid surface for promoting dropwise liquid condensation further comprises an anchoring structure binding the array. The array may be bound to any part of the anchoring structure.

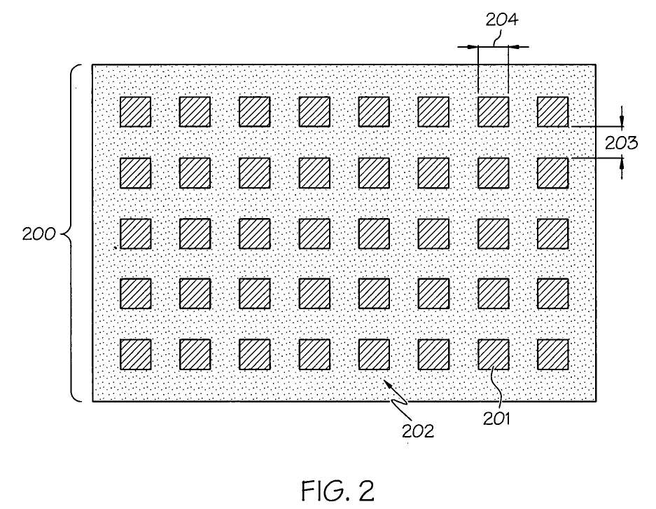

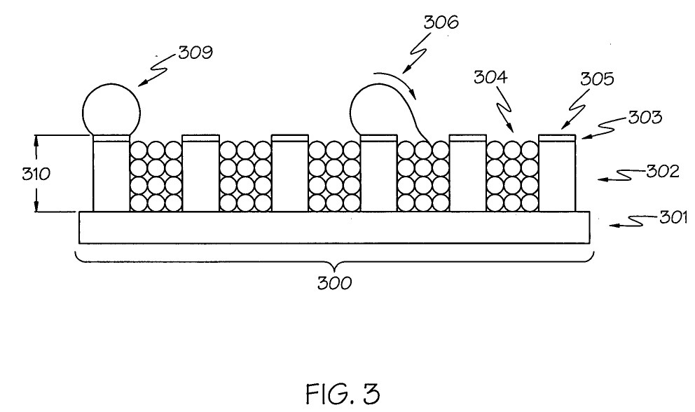

In an embodiment, a median spacing characterizes the plurality of raised structures comprising the array. As shown in FIG. 2, array (200) may comprise a median spacing (203) between raised structures (201), which are bound to the anchoring structure and comprise the array. Spacing in the array may be regular, irregular, or random. In an embodiment, the median spacing between the plurality of raised structures ranges from about 100 nm to about 10 mm and all sub-ranges thereof. In another embodiment, a median width characterizes the plurality of raised structures comprising the array. As shown in FIG. 2, array (200) may comprise a median width (204) of the plurality of raised structures comprising the array. The median width may be measured at any cross-sectional point on the raised structure. For point of reference in the description of embodiments hereinbelow, median width refers to measurements made at distal ends of the raised structures. In an embodiment, the median width of the plurality of raised structures may range from about 10 nm to about 1 mm and all subranges thereof. In another embodiment, a median height characterizes the plurality of raised structures comprising the array. As shown in FIG. 3, array (300) may comprise a median height (310) measured from anchoring surface (301) to distal end (303) of the raised structures comprising the array. In an embodiment, the ratio of median height/median width ranges from about 0.1 to about 10 and all subranges thereof. One skilled in the art will recognize that the median spacing, median width, and median height may be varied through considerable ranges depending on specific application requirements, and such variation may be used freely to operate within the spirit and scope of the present disclosure. As described hereinabove, the plurality of raised structures comprising the array may comprise at least one geometric shape. In the non-limiting embodiment shown in FIG. 2, raised structure (201) comprises a square prism or column.

Distal ends of the plurality of raised structures comprise the hydrophobic surface in an embodiment of the disclosure. In some embodiments, the distal ends comprise at least one convex surface. In other embodiments, the distal ends comprise at least one substantially planar surface. In some embodiments, the substantially planar surface is inclined. The incline varies between about 10 degrees and about 89 degrees and all subranges thereof in an embodiment. In some embodiments, the incline varies between about 30 degrees and about 70 degrees. In still other embodiments, the incline varies between about 45 degrees and about 60 degrees. The distal ends are covered with at least one hydrophobic substance in an embodiment. The hydrophobic substance comprises a textured surface in an embodiment. In one embodiment, the hydrophobic substance provides a contact angle with water greater than about 70 degrees. In a further embodiment, the hydrophobic substance provides a contact angle with water greater than about 120 degrees.

In embodiments of the hybrid surface disclosed hereinbelow, the plurality of hydrophilic pores comprises a plurality of micro-capillaries. In an embodiment, a median radius characterizes the plurality of micro-capillaries. In embodiments disclosed hereinbelow, the median radius ranges from about 10 nm to about 1 mm. The micro-capillaries may be constructed from at least one material selected from the group including, but not limited to, glass, diamond, metals, ceramics, polymers, and combinations thereof. It is to be understood that the term metal comprises elemental metallics, alloys, intermetallic compounds, and other such compositions comprising metals, such as aluminides. As shown in FIG. 2, micro-capillaries (202) are interspersed between raised structures (201) comprising array (200). In the non-limiting embodiment of array (300) shown in FIG. 3, the micro-capillaries (304) are interspersed between the raised structures (302) up to the distal ends (303) of the raised structures. In the embodiment shown in FIG. 3, hydrophobic substance (305) covers distal ends (303) of raised structures. The micro-capillaries (304) are interspersed between raised structures (302), wherein the interspersing of micro-capillaries (304) is at or below hydrophobic substance (305). The plurality of micro-capillaries may protrude out the sides of the array, through the bottom of the anchoring structure comprising the array, or any combination thereof.

The hybrid surface may be further characterized by migration of condensed liquid droplets on the hybrid surface. In an embodiment, a migration of condensed liquid droplets on the hybrid surface comprises movement from the hydrophobic surface to the plurality of micro-capillaries. Movement comprises motion influenced by capillary forces. Movement also comprises motion through the plurality of micro-capillaries. As shown in FIG. 3, a droplet (309) may be condensed on hydrophobic substance (305) at the distal end (303) of raised structure (302). Since hydrophobic substance (305) has a low wettability, droplet (309) may be easily dislodged from hydrophobic substance (305) and transported to plurality of micro-capillaries (304). FIG. 3 shows droplet (306) being dislodged from hydrophobic surface (305) and being drawn into plurality of micro-capillaries (304). Capillary forces (capillary action) influence the motion of droplet (306) to and through the plurality of micro-capillaries (304). Migration further comprises removing the condensed liquid droplets from the hybrid surface in an embodiment. The condensed liquid enters the micro-capillaries, travels through the micro-capillaries, and exits from the opposite end of the micro-capillaries in comprising the removing step. Liquid exiting the micro-capillaries may be collected in a reservoir or returned to the source from which it was initially vaporized.

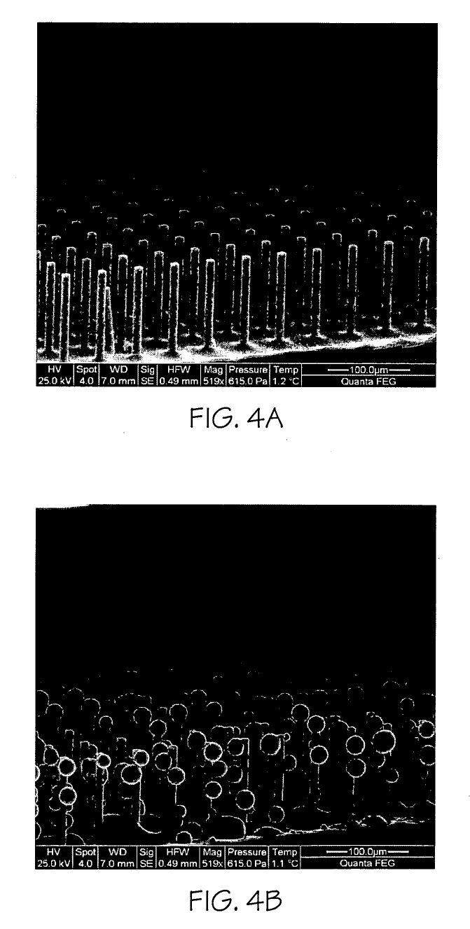

FIG. 4 shows an SEM image of an embodiment of a hydrophobic surface before (FIG. 4A) and after (FIG. 4B) the condensation of water on the surface. Note that the hydrophobic surface shown in FIG. 4 does not embody a plurality of micro-capillaries interspersed through it; thus, the surface shown is not a hybrid surface. Further, the entire surface is coated with a hydrophobic substance, in contrast to the hybrid surface described hereinabove, wherein the distal ends of the raised shapes may be coated with a hydrophobic substance in an embodiment. The hydrophobic surface shown in FIG. 4 illustrates dropwise condensation on hydrophobic surfaces by way of example. Condensation occurs in a similar manner on the hybrid surfaces detailed hereinabove. As shown in FIG. 4B, water condenses on the raised columns of the surface in discrete drops. No evidence of thin films is evident on the columns. Condensation occurs on both the sides and the tops of the columns. As droplets are dislodged from the columns, pooling takes place at the bottom of the anchoring surface. In the hybrid surfaces disclosed herein, such pooling does not take place as the plurality of micro-capillaries carries condensed water away from the hybrid surface, freeing fresh nucleation sites for further condensation.

The hybrid surfaces disclosed herein may be used as a heat exchanger in an embodiment. The hybrid surface of the present disclosure is advantageous in applications as a heat exchanger, since it does not rely on gravitational forces or aerodynamic forces for shedding of condensed droplets from the cooling surface. In certain embodiments, the hybrid surface may be advantageously utilized to remove condensed droplets from the cooling surface at up to twenty times normal gravitational force. Under these high g-forces, gravity-assisted removal of droplets cannot be relied upon. As a further advantage, the hybrid structure has been designed to facilitate low wettability of the hybrid surface. As such when water droplets migrate from the hydrophobic surface to the plurality of micro-capillaries, the droplets ‘fall off’ the surface rather than ‘slide off.’ A ‘fall off’ mechanism leaves little of no residual liquid film behind on the hybrid surface, in contrast to a ‘slide off’ mechanism where a small residual film may be left behind. As will be evident to one having skill in the art, even a small residual liquid film lowers the thermal conductivity of the surface, reduces the efficiency of the surface in heat exchange applications, and eventually leads to filmwise condensation.

In other aspects, the present disclosure provides a method for constructing a hybrid surface for promoting dropwise liquid condensation. The method comprises the steps of providing an anchoring structure, preparing an array comprising a plurality of raised structures, and interspersing a plurality of hydrophilic pores between the plurality of raised structures. The plurality of raised structures comprise at least one geometric shape. The plurality of raised structures are also bound to the anchoring structure. Distal ends of the plurality of raised structures comprise a hydrophobic surface. In embodiments of the method for constructing a hybrid surface for promoting dropwise liquid condensation, the hybrid surface comprises at least one substance having a high thermal conductivity.

In certain embodiments of the method for constructing a hybrid surface for promoting dropwise liquid condensation, the hybrid surface is characterized by a median spacing between the plurality of raised structures, a median width of the plurality of raised structures, and a median height of the plurality of raised structures. In an embodiment of the method, the median spacing ranges from about 100 nm to about 10 mm and all sub-ranges thereof, the median width ranges from about 10 nm to about 1 mm and all sub-ranges thereof, and a ratio of median height/median width ranges from about 0.1 to about 10 and all sub-ranges thereof.

In certain embodiments of the method disclosed hereinabove, distal ends of the plurality of raised structures comprise at least one contour. The at least one contour comprises at least one feature selected from a group consisting of a convex surface, a substantially planar surface, and combinations thereof. In an embodiment of the method, distal ends of the plurality of raised structures may be covered with a hydrophobic substance, wherein the hydrophobic substance provides a contact angle with water greater than about 70 degrees. In a further embodiment, the hydrophobic substance provides a contact angle with water greater than about 120 degrees. In an embodiment, the hydrophobic substance comprises a textured surface. One skilled in the art will recognize that such texturing may affect the contact angle. Further, one skilled in the art will recognize that the choice of hydrophobic substance may be determined at least in part by the operating conditions required for the hybrid surface. Certain hydrophobic substances disclosed hereinabove may be more suitable for given operating temperatures based on their physical properties. Although there may be considerable variability in the choice of hydrophobic substance, all of the hydrophobic substances disclosed hereinabove may be used to operate within the spirit and scope of the disclosed method.

In embodiments of the method for constructing a hybrid surface for promoting dropwise liquid condensation, the plurality of hydrophobic pores comprises a plurality of micro-capillaries. In certain embodiments of the method disclosed herein, a median radius characterizes the plurality of micro-capillaries. In an embodiment, the median radius ranges from about 10 nm to about 1 mm and all sub-ranges thereof. In an embodiment of the method, the hybrid surface is characterized by a migration of condensed liquid droplets on the hybrid surface. Migration comprises movement from the hydrophobic surface to the plurality of micro-capillaries. Movement comprises motion influenced by capillary forces. Movement also comprises motion through the plurality of micro-capillaries. The capillary force is inversely proportional to the capillary diameter, so the capillary force for migrating droplets on the hybrid surface may be varied over a factor of about 10000. The micro-capillaries may be constructed from at least one material including, but not limited to, glass, metals, ceramics, polymers, and combinations thereof. As will be evident to those having skill in the relevant art, transportation of the condensed liquid under the influence of capillary forces may be advantageous when gravitation forces or aerodynamic forces are not reliable sources for displacement of liquid droplets from the hybrid surface.

In still other aspects, the present disclosure describes a heat transfer device comprising a hybrid surface for promoting dropwise liquid condensation. The heat transfer device comprises an anchoring structure, an array comprising a plurality of raised structures, and a plurality of hydrophilic pores interspersed between the plurality of raised structures. The plurality of raised structures comprise at least one geometric shape. The plurality of raised structures are also bound to the anchoring structure. Distal ends of the plurality of raised structures comprise a hydrophobic surface. The plurality of hydrophilic pores comprises a plurality of micro-capillaries. The hybrid surface comprising the heat transfer device comprises at least one substance having a high thermal conductivity. Dropwise liquid condensation comprises a heat transfer step in an embodiment.

In an embodiment of the heat transfer device, the distal ends of the raised structures are covered with a hydrophobic substance, wherein the hydrophobic substance provides a contact angle with water greater than about 70 degrees. In certain embodiments of the heat transfer device, the hydrophobic substance provides a contact angle with water greater than about 120 degrees.

In certain embodiments of the heat transfer device, the device further comprises a reservoir of working liquid in atmospheric contact with the hydrophobic surface. As used herein, the atmospheric contact indicates that the vapor of the working liquid reservoir may contact the hybrid surface. In an embodiment, the working liquid is water. At least a portion of the working liquid condenses in droplets on the hydrophobic surface of the heat transfer device in an embodiment. In an embodiment, the heat transfer device is characterized by a migration of condensed working liquid droplets on the hybrid surface. Migration comprises movement from the hydrophobic surface to the plurality of micro-capillaries. Movement also comprises motion influenced by capillary forces. Movement also comprises motion through the plurality of micro-capillaries. In an embodiment of the heat transfer device, migration of the working liquid comprises returning the working liquid to the reservoir of working liquid. In certain non-limiting embodiments of the disclosure, the reservoir of working liquid and hybrid surface of the heat transfer device further comprise a heat pipe.

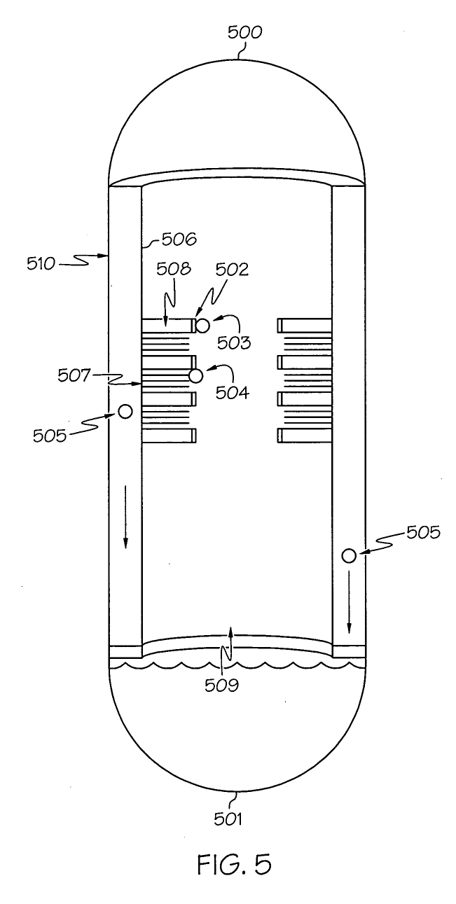

A non-limiting embodiment of a heat pipe comprising the heat transfer surface disclosed hereinabove is shown in FIG. 5. The heat pipe is a sealed system having no moving parts enclosed within outer surface (510). A working liquid reservoir (509) is enclosed within outer surface (510). In operation of the heat pipe, the end where the working liquid reservoir (509) resides comprises a hot end (501). The opposite end, where the heat transfer surfaces reside, comprises a cold end (500). Heating of working liquid reservoir (509) vaporizes at least a portion of the working liquid, and the vaporized liquid moves from hot end (501) to cold end (500) through thermal motion. At a point, the vaporized liquid condenses as droplets (503) on hydrophobic surface (502), giving up heat to cold end (500). Hydrophobic surface (502) is at the distal end of raised structure (508), which is in turn attached to anchoring structure (506). A plurality of micro-capillaries (507) is interspersed between the plurality of raised structures (508), on which hydrophobic surface (502) resides. The plurality of micro-capillaries (507) removes the falling condensed liquid droplets (504) from hydrophobic surface (503). Removal of the condensed liquid droplets occurs through the influence of capillary forces and transports the condensed liquid from the hybrid surface. After the removing step, the removed droplet (505) returns to working liquid reservoir (509).

The heat transfer surfaces and heat transfer devices described hereinabove may be used in any type of application where heat exchange may be needed. In any of these applications, liquids other than water may be condensed. Modification of the hydrophobic surfaces and hydrophilic pores may facilitate dropwise condensation of these alternative liquids and the efficient removal of condensate by capillary forces. It will be evident to one skilled in the art that such modifications to the heat transfer surfaces and heat transfer devices described hereinabove may be conducted fully within the spirit and scope of the disclosure provided herein. Possible non-limiting applications for the heat transfer surfaces and heat transfer devices disclosed herein include uses in power generation plants, chemical processing facilities, and desalination plants.

### EXPERIMENTAL EXAMPLES

The following examples are provided to more fully illustrate some of the embodiments of disclosed hereinabove. It should be appreciated by those of skill in the art that the techniques disclosed in the examples which follow represent techniques that constitute exemplary modes for practice of the disclosure. Those of skill in the art should, in light of the present disclosure, appreciate that many changes can be made in the specific embodiments that are disclosed and still obtain a like or similar result without departing from the spirit and scope of the disclosure.

### Example 1

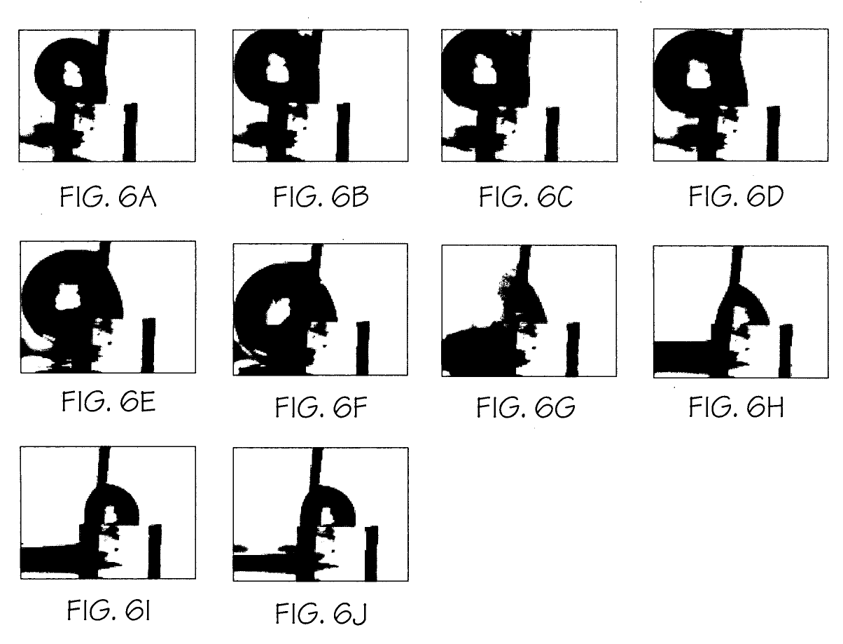

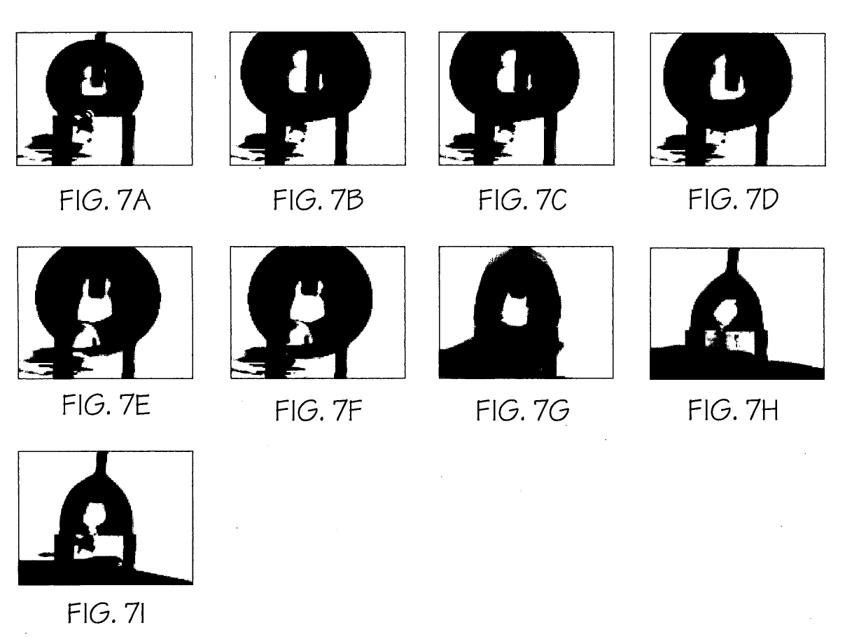

Representative Examples of the deposition, growth, and removal of water droplets from a hybrid surface are shown in FIGS. 6 and 7. The hybrid surface consisted of a hydrophobic PDMS layer surrounded by 200 nm AAO (anodized alumina) hydrophilic pores. The hydrophobic PDMS layer provided a contact angle of ˜100 degrees. The AAO pores acted as hydrophilic micro-capillaries. The hydrophilicity of the AAO pores was further increased by oxygen plasma treatment (for about 2 minutes at 100 mtorr). Water droplets were deposited on the PDMS layer as shown in FIGS. 6 and 7. The volume of the droplet was continuously increased using a syringe (simulating droplet growth during condensation) as shown in FIGS. 6A-6F and 7A-7F. When the droplet grew large enough and came into contact with the AAO surface, the droplet was instantly wicked into the hydrophilic AAO micro-capillaries and removed from the surface as shown in FIGS. 6G and 7G.

From the foregoing description, one skilled in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure, which is defined in the following claims.

What is claimed is:

1. An article comprising a hybrid surface for promoting dropwise liquid condensation, wherein said hybrid surface comprises:
an array comprising a plurality of raised structures, wherein said plurality of raised structures comprise at least one geometric shape, and wherein said plurality of raised structures comprise a hydrophobic surface; and
a plurality of hydrophilic pores interspersed between said plurality of raised structures.

2. The article of claim 1, wherein said dropwise liquid condensation comprises dropwise condensation of water.

3. The article of claim 1, further comprising:
an anchoring structure binding said array.

4. The article of claim 3, wherein a median spacing characterizes said plurality of raised structures, and wherein said median spacing ranges from about 100 nm to about 10 mm.

5. The article of claim 3, wherein a median width characterizes said plurality of raised structures, and wherein said median width ranges from about 10 nm to about 1 mm.

6. The article of any one of claims 3-5, wherein a median height characterizes said plurality of raised structures, and wherein a ratio of median height/median width ranges from about 0.1 to about 10.

7. The article of claim 3, wherein distal ends of said plurality of raised structures comprise said hydrophobic surface.

8. The article of claim 7, wherein said distal ends comprise at least one convex surface.

9. The article of claim 7, wherein said distal ends comprise at least one substantially planar surface.

10. The article of claim 9, wherein said substantially planar surface is inclined.

11. The article of claim 7, wherein said distal ends are covered with at least one hydrophobic substance.

12. The article of claim 11, wherein said hydrophobic substance comprises a textured surface.

13. The article of claim 11, wherein said hydrophobic substance provides a contact angle with water greater than about 70 degrees.

14. The article of claim 13, wherein said hydrophobic substance provides a contact angle with water greater than about 120 degrees.

15. The article of claim 11, wherein said plurality of hydrophilic pores comprises a plurality of micro-capillaries.

16. The article of claim 15, wherein a median radius characterizes said plurality of micro-capillaries, and wherein said median radius ranges from about 10 nm to about 1 mm.

17. The article of claim 15, wherein a migration of condensed liquid droplets on said hybrid surface comprises movement from said hydrophobic surface to said plurality of micro-capillaries, wherein said movement comprises motion influenced by capillary forces, and wherein said movement comprises motion through said plurality of micro-capillaries.

18. The article of claim 17, wherein said migration further comprises removing said condensed liquid droplets from said hybrid surface.

19. A method for constructing a hybrid surface for promoting dropwise liquid condensation, the method comprising:
providing an anchoring structure;
preparing an array comprising a plurality of raised structures, wherein said plurality of raised structures comprise at least one geometric shape;
wherein said plurality of raised structures are bound to said anchoring structure, and wherein distal ends of said plurality of raised structures comprise a hydrophobic surface; and
interspersing a plurality of hydrophilic pores between said plurality of raised structures.

20. The method of claim 19, wherein said hybrid surface comprises at least one substance having a high thermal conductivity.

21. The method of claim 20, wherein said hybrid surface is characterized by:
a median spacing between said plurality of raised structures, wherein said median spacing ranges from about 100 nm to about 10 mm;
a median width of said plurality of raised structures, wherein said median width ranges from about 10 nm to about 1 mm; and
a median height of said plurality of raised structures, wherein a ratio of median height/median width ranges from about 0.1 to about 10.

22. The method of claim 20, wherein said distal ends comprise at least one contour, wherein said at least one contour comprises at least one feature selected from a group consisting of a convex surface, a substantially flat surface, and combinations thereof.

23. The method of claim 20, wherein said distal ends are covered with a hydrophobic substance, and wherein said hydrophobic substance provides a contact angle with water greater than about 70 degrees.

24. The method of claim 23, wherein said hydrophobic substance provides a contact angle with water greater than about 120 degrees.

25. The method of claim 23, wherein said hydrophobic substance comprises a textured surface.

26. The method of claim 20, wherein said plurality of hydrophilic pores comprises a plurality of micro-capillaries.

27. The method of claim 26, wherein said a median radius characterizes said plurality of micro-capillaries, and wherein said median radius ranges from about 10 nm to about 1 mm.

28. The method of claim 26, wherein a migration of condensed liquid droplets on said hybrid surface comprises movement from said hydrophobic surface to said plurality of micro-capillaries, wherein said movement comprises motion influenced by capillary forces, and wherein said movement comprises motion through said plurality of micro-capillaries.

29. A heat transfer device comprising a hybrid surface for promoting dropwise liquid condensation, wherein said hybrid surface comprises:
an anchoring structure;
an array comprising a plurality of raised structures, wherein said plurality of raised structures comprise at least one geometric shape, wherein said array is bound to said anchoring structure, and wherein distal ends of said plurality of raised structures comprise a hydrophobic surface; and
a plurality of hydrophilic pores interspersed between said plurality of raised structures, wherein said plurality of hydrophilic pores comprises a plurality of micro-capillaries, and
wherein said hybrid surface comprising said heat transfer device comprises at least one substance having a high thermal conductivity.

30. The heat transfer device of claim 29, wherein said dropwise liquid condensation comprises a heat transfer step.

31. The heat transfer device of claim 29, wherein said distal ends are covered with a hydrophobic substance, and wherein said hydrophobic substance provides a contact angle with water greater than about 70 degrees.

32. The heat transfer device of claim 31, wherein said hydrophobic substance provides a contact angle with water greater than about 120 degrees.

33. The heat transfer device of claim 29 further comprising:
a reservoir of working liquid in atmospheric contact with said hybrid surface.

34. The heat transfer device of claim 33, wherein said working liquid is water.

35. The heat transfer device of claim 33, wherein at least a portion of said working liquid condenses in droplets on said hydrophobic surface.

36. The heat transfer device of claim 35, wherein a migration of condensed working liquid droplets on said hybrid surface comprises movement from said hydrophobic surface to said plurality of micro-capillaries, wherein said movement comprises motion influenced by capillary forces, and wherein said movement comprises motion through said plurality of micro-capillaries.

37. The heat transfer device of claim 36, wherein said migration comprises returning said working liquid to said reservoir of working liquid.

38. The heat transfer device of claim 37, wherein said reservoir of working liquid and said hybrid surface further comprise a heat pipe.
